(19) United States
(12) Patent Application Publication
(10) Pub. No.: US 2009/0011096 A1
(43) Pub. Date: Jan. 8, 2009

(54) Preservatives for food

(76) Inventor: Gil J. Bakal, New York, NY (US)

Correspondence Address: Gil Bakal, 24 Spielman Rd., Fairfield, NJ, 07004, US

(21) Appl. No.: 12/156,539

(22) Filed: Jun. 2, 2008

Related U.S. Application Data
(60) Provisional application No. 60/929,571, filed on Jul. 3, 2007.

(51) Int. Cl. A23L 3/3589; A23L 3/34; A23B 4/18; A23L 2/44; A23C 3/08

(52) U.S. Cl. 426/310; 426/532; 426/335; 426/332; 426/330.4; 426/330.5; 426/330.3; 426/330.2

(57) ABSTRACT

The combination of N^{α}-long chain alkyl of di basic amino acid alkyl ester acid salt biocides with liquid smoke compositions results in the extension of cidal activity not normally found in the preservation of foods treated solely with the amino acid biocides of this invention.

Cross-Reference to Related Cases Priority is herewith claimed under 35 U.S.C. §119(e) from U.S. Provisional.

Patent Application No. 60/933,696, filed on Jun. 8, 2007, entitled “Preservatives for Food” by Gil Bakal, et al. The disclosure of this Provisional Application is incorporated by reference herein its entirety.

### INTRODUCTION

Although N^{α}-long chain alkyl di basic amino acid alkyl ester acid salts have been known since the 1960's, one of the first patents to recommend these amino acids, specifically for food applications was U.S. Pat. No. 3,825,560 (issued Jul. 23, 1979). A number of derivatives are disclosed including N^{α}-cocoyl-L-arginine ethyl ester pyrolidone carboxylate and N^{α}lauroyl-L-arginine methyl ester hydrochloride. Since this publication there has been several more patents issued or published disclosing specifically N^{α}-lauroyl-L-arginine ethyl ester hydrochloride salt (LAE). These include U.S. Pat. No 5,780,658, which discloses a process to prepare LAE, as well as disclosing its use for food applications. U.S. Pat. No 7,074,447 B2 discloses an antimicrobial composition comprising LAE with potassium sorbate. U.S. Pat. No. 7,087,769 is another process patent suggesting its use for food. Two patent publications U.S. 2004/0166082 and U.S. 2004/0175350 disclosure di basic amino acid alkyl ester salts useful for cosmetic applications. U.S. 2004/0254232 covers oral care while U.S. 2004/0265443 covers food. U.S. 2005/0175747 discloses complexes formed between LAE and various anionic hydrocolloids. Finally a patent publication U.S. 2006/0177540 discloses a synergistic combination of LAE with two other ingredients for food applications.

All of the above references are incorporated into the body of our present invention.

One of the purposes of this invention is to formulate a LAE type biocide that will overcome a significant shortcoming found in the long-term use in certain food applications.

Another short-coming of LAE is its chemical/enzymatic hydrolysis of the ester functionality resulting in a lost of significant antimicrobial activity and water solubility. This is dependent on a number of variables e.g., presence of liptases and/or esterases, and pH. It has been found that the chemical hydrolysis is particularly rapid at pH≦4.0 or at pH≧8.0. For food applications with a pH in these critical ranges with the need to have relative long-term activity, LAE needs to have present other bioactive substances.

Also, LAE has a strong tendency to form complexes, since it has a guanidine chelating ligand. Both entropy and enthalpy thermodynamic properties are favored with LAE due to the potential formation of 5 and 6 membered reng. Furthermore, LAE readily reacts with anionic species e.g., carboxylates, basic amino acids, proteins having a residual negative charge, phosphato groups on nucleotides DNA and anionic phospholipids.

The second biocidal component of this invention useful in expanding the cidal spectra and duration of activity of LAE is liquid smoke.

Smoking is the process of flavoring, cooking, or preserving food by exposing it to the smoke from burning or smoldering plant materials, most often wood. Meats and fish are the most common smoked foods. In North America, hickory, mesquite, oak, pecan, alder, maple, and fruit tree woods such as apple, cherry, and plum are commonly used for smoking.

Wood is mostly made-up of cellulose, hemicellulose, and lignin. Upon pyrolysis and condensation of the vapors/liquids a wide variety of chemicals are formed. These vary depending on the type of wood and other processing variables. For example, about 150 compounds were chemically identified and reported in J. Agric. Food Chem. 1998, 46,1276-1285. These were characterized in the following classes of organic compounds: carboxylic acid, and alcohol derivatives; phenolic derivatives, methoxy phenol and derivatives; dimethoxy derivatives; terpenic compounds; alkyl aryl ethers; aromatic and aliphatics hydrocarbons.

It is generally believed that LS's anti-bacterial compounds are primarily organic acids e.g., acetic, propionic, which lower pH and destroy bacteria cell walls. Also, phenolic compounds, which are traditionally involved in flavor formation are well known bacteriocides.

The patent literature is replete with inventions to produce an acceptable liquid smoke. U.S. Pat. No. 4,154,866 teaches a method to produce liquid smoke from wood resulting in a tar containing 0.5 ppb 3,4-benzopyrene. U.S. Pat. No. 4,298,435 discloses a method to produce a product with superior toning (meat coloring). A process to produce a liquid smoke useful for coloring and flavoring edible food stuffs is described in U.S. Pat. No. 4,959,232. A liquid smoke product containing a minimum of carbonyl and phenol and having no staining index and high acidity to inhibit Listeria monocytogene re-inoculation and to extend the shelf-life of wieners is taught in U.S. Pat. No. 5,043,174. U.S. Pat. No. 5,637,339 teaches the use of activated carbon to reduce the tar component of liquid smoke. A method to produce a liquid smoke browning agent solution made by pyrolysing a deliqnified wood pulp is disclosed in U.S. Pat. No. 6,214,395, which also resulted in low favor. A method to increase the yield of liquid smoke by treatment with an alkali alkaline agent is described in U.S. Pat. No. 6,261,623 B1, useful as a color and flavor agent.

U.S. Pat. No. 6,541,053 B2 teaches the use of a specific type of liquid smoke known as Code V for treating collagen, which is then used as a casing for food products without any adverse effect on the taste.

Lastly Patent Application Publication U.S. 2005/0175746 A1 describes a liquid smoke to confer antimicrobial action on food substrates without imparting smoky flavors.

All of the above U.S. Patents and one journal article are incorporated into the body of this patent application.

Purpose of the Invention

While LAE has some outstanding food additive properties, particularly its complete breakdown into endogenous natural products resulting in very low overall toxicity, it does have some short-comings.

For example LAE is strongly positive charged, due to the guanidine group which retains its charge even in alkaline aqueous solutions. The isoelectronic point of the guanidine group in L-arginine is about pH 10-11.

This natural phenomenon causes LAE to react with many negatively charged molecules found in various foods like basic amino acids, negatively charged nucleotides, polysaccarides, enzymes, etc.

The interaction of oppositely charged species is both kinetically and thermodynamically dependent. Thus the loss of LAE by this mechanism will occur at various rates depending on the micro-environment.

This invention teaches the use of liquid smoke as a co-biocide with LAE to provide several advantages not observed by using LAE alone.

Generally speaking, liquid smoke is used for meats to confer flavor/taste and rarely as a effective preservatives.

By microbial and organoleptic testing, it has been found that the synergistic addition of LAE and liquid smoke has resulted in several improvements as listed below:
broaden antimicrobial activity
lengthen the antimicrobial kill time
synergy of co-biocides is cost-effective
co-biocides provide an organoleptic satisfying product.

Experimentally, it has been found that the level of LAE can be from about 10 to about 500 ppm, preferably from about 25 to about 250 ppm, in the final treating solution.

The liquid smoke found to extend the antimicrobial spectra of activity of dibasic amino acid ethyl ester salts at levels of from about 0.05 to about 5.0 wt. %, preferably from about 0.10 to about 3.0 wt. % in the final treating solution.

It is preferred to use the invention compositions for the preservation of products, like for meat, poultry, crustaceans, fish, beverages, juices, wines, beers, vegetables, salads, sauces, confectionery, bakery, pre-cooked meals, ready-to-serve meals, dairy products and o/w emulsions. A list of partial specific food products can be found in U.S. 2004/0265443A1, and is thereby incorporated in the specifications of this application. Additional food uses contemplated by someone who is skilled in the food science would also be applicable.

Surfactants

Certain applications for LAE might require a surfactant to solubilize either the LAE or some incipient in a particular formulation.

Experimentally, it has been determined that the preferred surfactants, which form micelles, microemulsions or emulsions with the compositions of this invention, are by and large, either of the amphoteric and non-ionic type, or combinations thereof. Highly charged anionic surfactants have the potential to reduce the overall bioactivity of these complexes by causing some degree of precipitation, thereby lessening its effective.

It was also found that certain cationic surfactants, sometimes in combination with non-ionic and/or amphoteric surfactants are effective in forming stable emulsions and/or microemulsions.

Surfactants that carry a positive charge in strongly acidic media, carry a negative charge in strongly basic media, and form zwitterionic species at intermediate pH's are amphoteric. The preferred pH range for the stability and effectiveness is from about 2.0 to about 9.0. Usually under this pH range the amphoteric surfactant is mostly or fully in the zwitter (overall neutral charge) form, thereby negating any serious dilution of bioactivity of the compositions of this invention.

There are several classes of amphoteric surfactants useful for preparing microemulsions or emulsions for the complexes of this invention. These are:
N-alkylamino acids
alkyldimethyl betaines
alkylamino betaines
sulfobetaines
imidazolines
amino or imino propionates

Some of the above amphoteric surfactants have moderate to good antimicrobial activity against certain microorganism, and hence can be synergistic.

Nonionic surfactants have also been found to be useful to form small particle micelles for these complexes. These can be classified as the following:
alcohols
alkanolamides
Amine oxides
Esters
ethoxylated(propoxylated)carboxylic acids
ethoxylated(propoxylated)glycerides
glycol esters (and derivatives)
mono(di)glycerides
polyglycerol esters
polyhydric alcohol esters and ethers
sorbitan/sorbital esters
di(tri)esters of phosphoric acid
Esters
ethoxylated(propoxylated)alcohols
ethoxylated(propoxylated)lanolin
ethoxylated(propoxylated)polysiloxanes
ethoxylated-propoxylated block copolymers

Two suitable cationic surfactants include D,L-2-pyrrolidone-5-carbo-xylic acid salt of ethyl-N-cocoyl-L-arginate (CAE), marketed by Ajinomto and cocamidopropyl, cocamidopropyl PG dimonium chloride phosphate (PTC), marketed by Uniqema, and the like.

It has been observed that the choice of an effective surfactant system will differ to some degree for each biocidal formulation. The choice will depend on the surfactants hydrophilic-lipophilic balance (HLB) to form a stable small particle micelle in an aqueous or aqueous cosolvent medium solution. Also the combination of two or more amphoteric or a amphoteric-nonionic system or two or more nonionic surfactants can also be utilized to achieve satisfactory results.

Solvents

Solvents that are useful for this invention must be non-toxic and classified as GRAS acceptable. They must also be non-irritating and have excellent solubility properties for all of the ingredients found in the formulations used in this invention.

Some examples include ethanol, glycerine, sorbital, polyethylene glycols, propylene glycol, glycerol monoesters (C₁-C₁₀), triacetin, polysorbate and the like. Combination of these solvents can also be used.

Experimental

In general liquid smoke is primarily used in foods to give a desirable color, and provide a favorable consumer taste. Its antimicrobial action is only nominal. Previously, U.S. Pat. No. 5,043,174 described a liquid smoke product known as Zesti-Smoke™ (Code 10) available from Mastertaste of Crossville, Tenn., which prevents post-processing re-inoculation with Listeria monocytogenes. An improved liquid smoke similar to that described in U.S. Pat. No. 5,043,174 is described in U.S. Patent Application Publication 2005/0175746 A1. Both of these inventions are incorporated into the body of our present invention and represent the types of liquid smoke, which are used in our microbiological studies. Similar liquid smoke products are functional as well.

### PATENT SUPPORT

Experiment#1.—Improving Shelf-Life of Hot Dogs

Purpose:

To evaluate the efficiency of LAE/liquid-smoke combination to inibit the re-growth of L. monocytogenes over long-term shelf life in hot dog purge.

Method:

Hot dogs inoculated with a l. monocytogenes pool, stored at refrigeration, sampled for 150 days.

Samples: water, 33 ppm LAE in water, 33 ppm LAE in liquid smoke.

Inoculum: 3 organism l. monocytogenes pool (1 ml)

Dilutions with modified letheen broth and plated with modified oxoid (MOX) agar

Data:

Conclusion: LAE in liquid smoke had better bacteriostasis than LAE alone.

External lab confirmed these conclusions by repeating the experiment above using a 5 strain L. monocytogenes pool recovered from outbreaks as the inoculum and treating the samples with the following variables: LAE alone, liquid smoke alone, and combinations ranging concentration LAE/liquid smoke combination had both inhibition and suppression of re-growth.

Experiment#2—Shelf-Life of Raw Pork Products

Purpose:

To evaluate the efficacy of LAE/liquid smoke combination to extend the shelf-life of raw pork products.

Method:

Samples of various surface treated pork products were treated with LAE/liquid smoke combination and monitored for shelf-life improvement versus untreated samples. Visual observations and microbiological testing data served as markers for end of shelf-life.

Data:

| | | |
|---|---|---|
| Ribs | 45% Improvement in shelf-life | 9 days extra |
| Pumped Rib | 85% Improvement in shelf-life | 13 days extra |
| Tenderloins* | >10% Improvement in shelf-life | >3 days extra |

*Tenderloin treated samples were still good on the last day of testing. End shelf-life date not determined.

Conclusion: Treated samples showed an improvement in shelf-life over untreated samples.

Experiment #3—Shelf-Life of Fresh Sausage

Purpose:

To evaluate the efficacy of LAE/liquid smoke combination to extend the shelf-life fresh sausage products.

Method:

Fresh Sausage were treated with LAE in liquid smoke sufficient to cover the surface of the product and monitored for shelf-life improvement versus untreated sausage. Monitoring consisted of visual inspections with a date being given when sausage was deemed unacceptable and product was marked as failed.

Data:

| Sample # | Control Failed Day | Sample # | Cytostat Failed Day |
|---|---|---|---|
| 1 | 26 | 1 | 34 |
| 2 | 34 | 2 | 40 |
| 3 | 22 | 3 | 34 |
| 4 | 22 | 4 | 34 |
| 5 | 38 | 5 | 38 |
| 6 | 26 | 6 | 40 |
| 7 | 38 | 7 | 34 |
| 8 | 22 | 8 | 40 |
| 9 | 40 | 9 | 34 |
| 10 | 40 | 10 | 34 |
| 11 | 22 | 11 | 40 |
| 12 | 28 | 12 | 36 |
| 13 | 22 | 13 | 36 |
| AVG. | 29.4 | AVG. | 36.5 |

Conclusion: Treated samples showed an average of a 7 day improvement over untreated samples

1. A composition comprising N^{α}-alkyl-dibasic amino acid alkyl ester salts plus liquid smoke useful as a combination of antimicrobial agents in foods.

2. Di basic amino acid derivatives as described in claim 1 whereby said amino acid is arginine, lysine or histidine.

3. The anions of the di basic amino acid derivatives of claim 1 comprise halides, sulfate, organocarboxylate, organohydroxy carboxylate, phosphate, or phenolate.

4. The antimicrobial compositions of claim 1 wherein the di basic amino acid derivatives of claim 1 are present from about 10 ppm wt. %.

5. The antimicrobial compositions claim 1 wherein the liquid smoke is present in the range of about 0.05 wt. % to about 5.0 wt. %.

6. The antimicrobial agents as described in claim 1 whereby a non-ionic, cationic, anionic, or amphoteric surfactants or combination thereof are added, from about 0.01 wt. % to about 2.0 wt. % based on the weight of the antimicrobial agents formulation.

7. The antimicrobial agents as described in claim 1 whereby a non-ionic, cationic, anionic, or amphoteric solubilizers or combinations thereof are added from about 0.1 wt. % to about 10 wt. % based on the weight of the formulation.

8. The antimicrobial agent as described in claim 1 whereby a non-toxic, GRAS approved solvent like ethanol, propylene glycol, sorbitol, polysorbate is added from about up to 5 wt. % in the final usage formulation.

9. A method to preserve food, which comprises adding a mixture of N^{α}-alkyl-di basic amino acid alkyl combined with liquid smoke.

10. A method as described in claim 8 whereby the di basic amino acid derivatives are arginine, lysine or histidine.

11. A method as described in claim 8 whereby the liquid smoke has a very low amount of tar, polyaromatic compounds and/or ash.

12. A method as described in claim 8 whereby the liquid smoke consist chiefly of organic acids, carbonyl compounds, and phenolic compounds.

13. A combination of GRAS approved biocides for food applications comprising;
a) cationic biocides
b) liquid smoke, and
c) optionally a surfactant, solubilizer, solvent, hydrotrope, or combination thereof.

14. A food antimicrobial solution as described in claim 13, where said solution has a pH between 2-9.

15. A surfactant as described in claim 13 consisting of an ethoxylated sorbitol with a HLB of about 10 to about 22 or higher, or a di or tri block polyethylene oxide and polypropylene oxide with a major amount of polyethylene oxide or combinations thereof.

16. The method of claim 1 wherein the food products are meat, meat substitutes or poultry products.

17. The method of claim 1 wherein the food products are fish, crustaceans, fish substitutes or crustacean substitutes.

18. The method of claim 1 wherein the food products are vegetables, greens, sauces, and o/w emulsions.

19. The method of claim 1 wherein the food products or beverages, juices, wines or beers.

20. The method of claim 1 wherein the food products are dairy, egg-based, jam, jelly, bakery, or confectionery products.

21. The method of claim 1 wherein the food products are pre-cooked meal and ready to-serve meal products.

22. Method of preservation of food products, wherein LAE and liquid smoke is added separately or as an admixture is applied as a solution, dispersion, or solid or is sprayed to a food product before, during and/or after manufacture.

23. Method of preservation of food products, wherein LAE and liquid smoke is applied by surface treatment or mixed in the composition.
